(19) United States
(12) Patent Application Publication
(10) Pub. No.: US 2009/0200782 A1
(43) Pub. Date: Aug. 13, 2009

(54) TOWED VEHICLE STABILIZING APPARATUS

(75) Inventors: Jeffrey Albrecht, Goshen, IN (US); Charles J. Dietz, Niles, MI (US)

Correspondence Address: BARNES & THORNBURG LLP, P.O. BOX 2786, CHICAGO, IL, 60690-2786, US

(73) Assignee: LIPPERT COMPONENTS, INC., Goshen, IN (US)

(21) Appl. No.: 12/027,415

(22) Filed: Feb. 7, 2008

(51) Int. Cl. B60S 9/04

(52) U.S. Cl. 280/763.1

(57) ABSTRACT

An apparatus for stabilizing a towed vehicle when stationary, such as a fifth wheel trailer. A pair of independent stabilizing legs is attached to the pin box for towed vehicle, each of the leg being attached to an opposite side of the pin box by means of a universal joint. When deployed, a fine adjustment extends between the legs for altering the leg spacing. When stowed, each of the leg is located in a bracket shaped to engage and retain the leg.

### BACKGROUND OF THE INVENTION

This invention relates to towed vehicles, such as fifth wheel trailers, and in particular to an apparatus for stabilizing a towed vehicle when stationary.

Because of suspension systems and the nature of the structure of towed vehicles, it is important to stabilize a vehicle once it is in its stopped and stationary position and being used. Thus, various apparatus has been developed for that purpose.

U.S. Pat. No. 4,905,953 discloses a fifth wheel stabilizer comprising a pair of splayed legs extending on opposite sides of the pin box. The legs must be removed when the fifth wheel vehicle is towed.

U.S. Pat. No. 5,474,330 discloses a trailer stabilizing apparatus comprising a pair of outboard legs attached to opposite ends of the vehicle bumper. When the vehicle is towed, the legs can be folded and retained in place.

U.S. Pat. No. 6,062,524 discloses a stabilizing apparatus that is attached to the king pin of a fifth wheel recreational vehicle. The apparatus must be removed when the vehicle is towed. Similar structures are shown in U.S. Pat. Nos. 4,596,371 and 4,708,362.

Stabilization has always been a concern in connection with towed vehicles. Other types of stabilizing apparatus are disclosed in U.S. Pat. Nos. 2,924,463; 2,979,304; 3,367,614; 5,575,492 and 6,095,474.

### SUMMARY OF THE INVENTION

The invention is directed to an apparatus for stabilizing a towed vehicle when stationary, where the towed vehicle has a pin box for securing the towed vehicle to a towing vehicle. A pair of independent stabilizing legs is provided, with each stabilizing leg having an upper end for securing proximate one side of the pin box and the lower end having a ground-engaging foot. A universal joint is provided at each upper end. A fine adjustment is secured to and extends between the legs, with the fine adjustment having a mechanical coupling for incrementally altering spacing between the legs.

In accordance with the preferred form of the invention, the mechanical coupling comprises a turnbuckle. The turnbuckle is preferably located in a chain extending between the legs, although it can be located in other types of interconnection between the legs, such as cables, ropes and the like.

In accordance with the preferred form of the invention, each universal joint comprises a double joint secured to the pin box. The legs are adjustable in length, and each leg preferably comprises a pair of telescopic leg sections.

Means is provided for stowing the legs in a non-stabilizing orientation. In accordance with the disclosed invention, that means comprises a pair of brackets, with each bracket being shaped to engage and retain a respective one of the legs.

### BRIEF DESCRIPTION OF THE DRAWINGS

The invention is described in greater detail in the following description of examples embodying the best mode of the invention, taken in conjunction with the drawing figures, in which:

FIG. 1 is a perspective view of the apparatus according to the invention when secured to the pin box of a towed vehicle,

FIG. 2 is a top plan view of the apparatus of FIG. 1,

FIG. 3 is a front elevational view of the apparatus of FIG. 1,

FIG. 4 is a front elevational view, similar to FIG. 3, and showing the pin box in place on a towed vehicle,

FIG. 5 is an enlarged view of the mechanical coupling extending between the legs of the apparatus,

FIG. 6 is an enlarged view of the foot of one of the legs, and

FIG. 7 is an enlarged view of one of the legs when stowed in a non-stabilizing orientation.

### DESCRIPTION OF EXAMPLES EMBODYING THE BEST MODE OF THE INVENTION

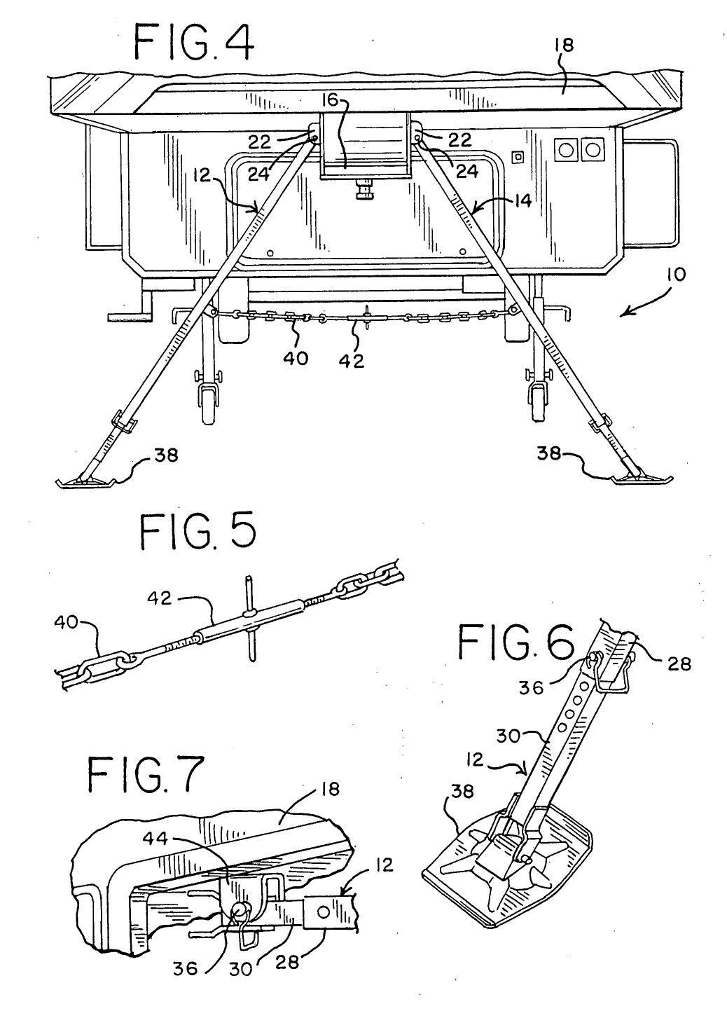

The stabilizing apparatus according to the invention is shown generally at 10 in the drawing figures. The stabilizing apparatus comprises a pair of opposite legs 12 and 14, each having an upper end secured on an opposite side of a pin box 16 for a towed vehicle 18 (FIG. 4).

Each of the legs 12 and 14 has an upper end at which a universal joint 20 is secured. As illustrated, each universal joint 20 is a double joint, comprising a bracket 22 having a pin 24 rotatably attached to a respective one of the legs 12 and 14, and a further pin 26 rotatably coupling the bracket 22 to the pin box 16. The pins 24 and 26 may be conventional, and are therefore not described in greater detail.

Each of the legs preferably comprises a pair of telescopic leg sections. Thus, the leg 12 comprises a pair of leg sections 28 and 30, with the leg section 30 telescoping within the leg section 28. Similarly, the leg section 14 comprises a pair of leg sections 32 and 34, with the leg section 34 telescoping within the leg section 32. For adjustment purposes, the lower leg sections 30 and 34 have a series of holes, as illustrated, and each of the upper leg sections has a conforming and aligned pair of holes through which a removable pin 36 is installed. Thus, the lengths of the leg 12 and 14 can be lengthened or shortened as appropriate. Alternatively, the legs 12 and 14 can be formed with screw-type telescoping sections, similar to those shown in U.S. Pat. No. 5,474,330. Other types of adjustability can be provided, as will be evident to one skilled in the art.

Each of the legs 12 and 14, at its lower end, has a ground-engaging foot 38. The feet 38 may be as simple as ends of the respective legs 12 and 14, or can be more sophisticated structures providing a wider footprint at the end of the respective legs. The ground-engaging foot 38 is well-known to one skilled in the art, and is not described further.

For fine adjustment, a mechanical coupling 40 is provided, secured to and extending between the legs 12 and 14. The mechanical coupling 40 is incrementally adjustable for altering spacing between the legs 12 and 14. To that end, the mechanical coupling includes a turnbuckle 42 (FIGS. 4 and 5) which, in a conventional fashion, is turned to incrementally change the length of the mechanical coupling 40 and therefore the spacing between the legs 12 and 14. The mechanical coupling may comprise a chain, cable, rope or any other suitable means of accommodating the turnbuckle 42 and permitting spacial adjustment of the legs 12 and 14.

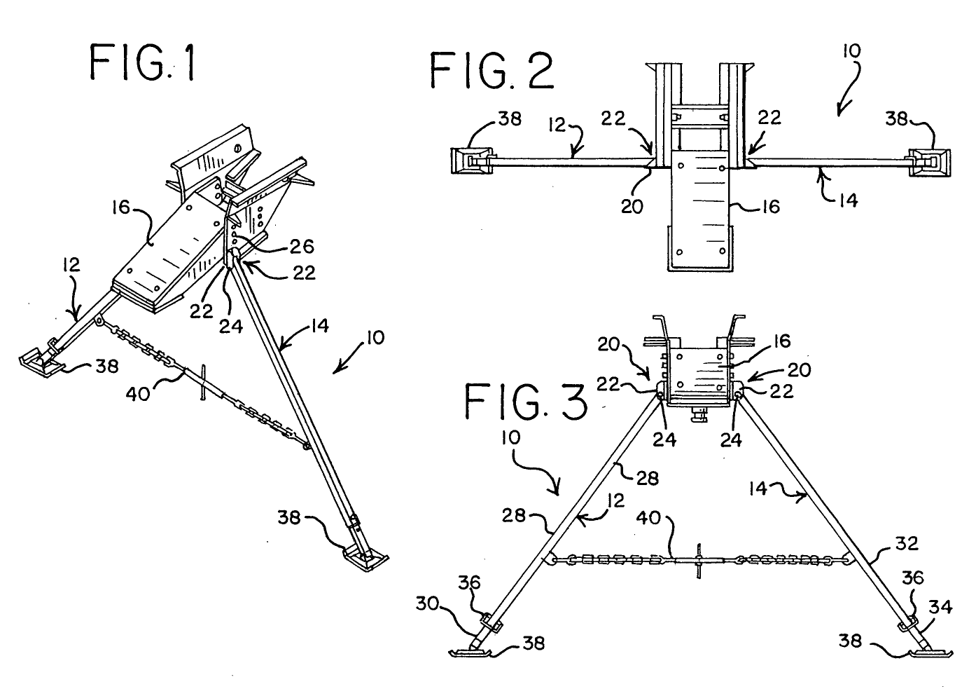

Because of the universal nature of the joints 20, the leg 12 and 14 can be pivoted upwardly (in relation to FIGS. 1, 3 and 4), as well as rearwardly (in relation to FIGS. 1, 2 and 4). Thus, when the towed vehicle 18 is being transported, the legs 12 and 14 need not be removed. Instead, the legs can be rotated underneath the vehicle 18 for a rapid deployment once the vehicle is parked and stationary. To this end, a pair of brackets 44 is mounted underneath the towed vehicle 18, and, quite advantageously, the removable pin 36 can be used to secure the stowed legs 12 and 14 in place. As shown in FIG. 7, the pin 36 is removed from its connection of the leg sections 28 and 30 (or 32 and 34), and, with the foot 38 removed, passes through the bottom of the leg section 28 (or 32) through an appropriate aperture in the bracket 44. The legs 12 and 14 are thus immobility retained in a stowed, non-stabilizing orientation beneath the towed vehicle 18. While the foot 38 is removed in the illustration of FIG. 7, in appropriate instances, the foot 38 may remain in place with the legs stowed in the non-stabilizing orientation.

Various changes may be made to the invention without departing from the spirit thereof or scope of the following claims.

What is claimed is:

1. An apparatus for stabilizing a towed vehicle when stationary, the towed vehicle having a pin box for securing the towed vehicle to a towing vehicle, the apparatus comprising:
a. a pair of independent stabilizing legs, each stabilizing leg having an upper end for securing proximate one side of the pin box and a lower end having a ground-engaging foot,
b. a universal joint that each upper end, and
c. a fine adjustment secured to and extending between said legs, said fine adjustment having a mechanical coupling for incrementally altering spacing between said legs.

2. The apparatus according to claim 1, in which said mechanical coupling includes a turnbuckle.

3. The apparatus according to claim 2, in which said turnbuckle is located in a chain extending between said legs.

4. The apparatus according to claim 1, in which said universal joint comprises a double joint secured to said pin box.

5. The apparatus according to claim 1, in which said legs are adjustable in length.

6. The apparatus according to claim 5, in which each leg comprises a pair of telescopic leg sections.

7. The apparatus according to claim 1, including means for stowing said legs in a non-stabilizing orientation.

8. The apparatus according to claim 7, in which said stowing means comprises a pair of brackets, each bracket being shaped to engage and retain a said leg.

9. An apparatus for stabilizing a towed vehicle when stationary, the towed vehicle having a pin box for securing the towed vehicle to a towing vehicle, the apparatus comprising:
a. a pair of independent stabilizing legs, each stabilizing leg having an upper end for securing at one side of the pin box and a lower end,
b. a double joint at each upper end secured to said pin box,
c. a fine adjustment secured to and extending between said legs, said fine adjustment having a mechanical coupling for incrementally altering spacing between said legs, and
d. means for stowing said legs in a non-stabilizing orientation.

10. The apparatus according to claim 9, in which said mechanical coupling includes a turnbuckle.

11. The apparatus according to claim 10, in which said turnbuckle is located in a chain extending between said legs.

12. The apparatus according to claim 9, in which said legs are adjustable in length.

13. The apparatus according to claim 12, in which each leg comprises a pair of telescopic leg sections.

14. The apparatus according to claim 9, in which said stowing means comprises a pair of brackets, each bracket being shaped to engage and retain a said leg.
